(19) United States
(12) Patent Application Publication
(10) Pub. No.: US 2025/0336345 A1
(43) Pub. Date: Oct. 30, 2025

(54) DISPLAY PANEL AND AFTERGLOW REMOVAL METHOD THEREFOR

(71) Applicant: SAMSUNG ELECTRONICS CO., LTD., Suwon-si (KR)

(72) Inventors: Jiha Kim, Suwon-si (KR); Jongsu Oh, Suwon-si (KR); Donghun Lee, Suwon-si (KR); Chulgyu Jung, Suwon-si (KR)

(73) Assignee: SAMSUNG ELECTRONICS CO., LTD., Suwon-si (KR)

(21) Appl. No.: 19/261,514

(22) Filed: Jul. 7, 2025

Related U.S. Application Data
(63) Continuation of application No. PCT/KR2024/001337, filed on Jan. 29, 2024.

(30) Foreign Application Priority Data
Feb. 23, 2023 (KR) 10-2023-0024074
Jun. 16, 2023 (KR) 10-2023-0077728

(51) Int. Cl. G09G 3/32

(52) U.S. Cl. CPC G09G 3/32; G09G 2300/0819; G09G 2320/0247; G09G 2320/0257

(57) ABSTRACT

A display panel includes a plurality of pixels provided in a matrix, each pixel including a plurality of sub-pixels. Each pixel of the plurality of sub-pixels includes a light-emitting element, and a pixel circuit that provides a driving current to the light-emitting element in each sub-frame period of a plurality of sub-frame periods within a frame period. The pixel circuit includes a reset circuit that removes charges remaining in the light-emitting element during a reset period within the frame period other than the plurality of sub-frame periods.

### CROSS-REFERENCE TO RELATED APPLICATIONS

This application is a bypass continuation of International Application No. PCT/KR2024/001337, filed on Jan. 29, 2024, which is based on and claims priority to Korean Patent Application No. 10-2023-0024074, filed on Feb. 23, 2023, in the Korean Intellectual Property Office, and Korean Patent Application No. 10-2023-0077728, filed on Jun. 16, 2023, in the Korean Intellectual Property Office, the disclosures of which are incorporated by reference herein in their entireties.

### BACKGROUND

### 1. Field

The present disclosure relates to a display panel capable of removing afterglow of a light-emitting element, and an afterglow removal method thereof.

### 2. Description of Related Art

A display panel that drives a light-emitting element such as a red light-emitting diode (LED), a green LED, or a blue LED as a sub-pixel may emit the LED, thereby expressing a gradation of the sub-pixel.

A flicker phenomenon may occur in the display panel based on a method for driving the display panel, and it is difficult to accurately implement black gradation due to charges remaining in the LED that occurs based on driving of the display panel.

### SUMMARY

According to an aspect of the disclosure, there is provided a display panel including: a plurality of pixels provided in a matrix, each pixel including a plurality of sub-pixels, wherein each pixel of the plurality of sub-pixels includes: a light-emitting element, and a pixel circuit configured to provide a driving current to the light-emitting element in each sub-frame period of a plurality of sub-frame periods within a frame period, and wherein the pixel circuit includes a reset circuit configured to remove charges remaining in the light-emitting element during a reset period within the frame period other than the plurality of sub-frame periods.

The reset period may be before a first sub-frame period among the plurality of sub-frame periods within the frame period.

The reset period may be after a last sub-frame period among the plurality of sub-frame periods within the frame period.

The reset circuit may include at least one transistor connected between the light-emitting element and a ground voltage, and wherein the at least one transistor may be configured to be turned on during the reset period and discharge the charges remaining in the light-emitting element to the ground voltage while being turned on.

The at least one transistor may include: a first transistor having a source terminal connected to an anode terminal of the light-emitting element, and a second transistor having a source terminal connected to a drain terminal of the first transistor and a drain terminal connected to the ground voltage, wherein the first transistor and the second transistor may be configured to be turned on based on a reset signal applied to a gate terminal of each of the first transistor and the second transistor during the reset period.

The at least one transistor may include a third transistor having a source terminal connected to an anode terminal of the light-emitting element and a drain terminal connected to the ground voltage, wherein a length of the third transistor may be greater than or equal to a predetermined value, and wherein the third transistor may be configured to be turned on based on a reset signal applied to a gate terminal of the third transistor during the reset period.

The light-emitting element may be a micro light-emitting diode (LED).

No blanking time may occur between the frame period and a frame period consecutive to the frame period.

According to an aspect of the disclosure, there is provided a method for removing afterglow in a display panel, in which a plurality of pixels, each pixel including a plurality of sub-pixels, are provided in a matrix form, each sub-pixel of the plurality of sub-pixels including a light-emitting element, the method including: providing a driving current to the light-emitting element in each sub-frame period of a plurality of sub-frame periods within a frame period; and removing charges remaining in the light-emitting element during a reset period within the frame period other than the plurality of sub-frame periods.

The reset period may be before a first sub-frame period among the plurality of sub-frame periods within the frame period.

The reset period may be after a last sub-frame period among the plurality of sub-frame periods within the frame period.

A reset circuit may include at least one transistor connected between the light-emitting element and a ground voltage, and wherein the at least one transistor may be turned on during the reset period and discharges the charges remaining in the light-emitting element to the ground voltage while being turned on.

The at least one transistor may include: a first transistor having a source terminal connected to an anode terminal of the light-emitting element, and a second transistor having a source terminal connected to a drain terminal of the first transistor and a drain terminal connected to the ground voltage, and wherein in the removing, the first transistor and the second transistor may be turned on by applying a reset signal to a gate terminal of each of the first transistor and the second transistor during the reset period.

The at least one transistor may include a third transistor having a source terminal connected to the anode terminal of the light-emitting element and a drain terminal connected to the ground voltage, wherein a length of the third transistor may be greater than or equal to a predetermined value, and wherein in the removing, the third transistor may be turned on by applying a reset signal to a gate terminal of the third transistor during the reset period.

The light-emitting element may be a micro light-emitting diode (LED).

### BRIEF DESCRIPTION OF THE DRAWINGS

The above and other aspects, features, and/or advantages of certain embodiments of the disclosure will be more apparent from the following description taken in conjunction with the accompanying drawings, in which:

FIG. 1 is a diagram for describing a pixel structure of a display panel according to an embodiment of the present disclosure;

FIG. 2 is a block diagram for describing a configuration of the display panel according to an embodiment of the present disclosure;

FIGS. 3A and 3B are conceptual diagrams showing a method for driving a display panel according to an embodiment of the present disclosure;

FIGS. 4A and 4B are block diagrams for describing a configuration of a display device according to an embodiment of the present disclosure;

FIG. 5 is a diagram for describing a pixel circuit according to an embodiment of the present disclosure;

FIGS. 6A and 6B are circuit diagrams of the pixel circuit according to an embodiment of the present disclosure;

FIGS. 7A and 7B are diagrams for describing a reset period according to an embodiment of the present disclosure;

FIGS. 8A and 8B are cross-sectional views of the display panel according to an embodiment of the present disclosure;

FIG. 8C is a plan view of a thin film transistor (TFT) layer according to an embodiment of the present disclosure; and

FIG. 9 is a flowchart for describing an afterglow removal method for a display panel according to an embodiment of the present disclosure.

### DETAILED DESCRIPTION

It should be understood that various embodiments of the present disclosure and terms used herein are not intended to limit technical features described in the present disclosure to specific embodiments, and rather are intended to include various modifications, equivalents, and substitutions of the corresponding embodiments.

Throughout the accompanying drawings, similar components are denoted by similar reference numerals.

A singular noun corresponding to an item is intended to include one or more of the items unless a relevant context clearly indicates otherwise.

In the present disclosure, an expression such as “A or B”, “at least one of A and B”, “at least one of A or B”, “A, B, or C”, “at least one of A, B, and C”, “at least one of A, B, or C”, or the like may include any one of the items listed together or all possible combinations thereof. For example, “A or B”, “at least one of A and B”, or “at least one of A or B” may indicate all of 1) a case in which A is included, 2) a case in which B is included, or 3) a case in which both A and B are included.

Terms such as “first” or “second” may be used simply to distinguish one element and another element from each other, and do not limit the corresponding components in any other respect (e.g., importance or order).

In case that a component (for example, a first component) is mentioned to be “coupled to” or “connected to” another component (for example, a second component) with or without terms “operatively or communicatively”, it should be understood that the component may be coupled to another component directly (e.g., in a wired manner) in a wireless manner or through a third component.

Terms “include”, “have”, or the like, specify the presence of features, numerals, steps, operations, components, parts, or combinations thereof mentioned in this document, and do not preclude the presence or addition of one or more other features, numerals, steps, operations, components, parts, or combinations thereof.

If a component is referred to as being “connected”, “coupled”, “supported”, or “in contact” with another component, it includes not only cases where the components are directly connected, coupled, supported, or in contact with each other, but also cases where the components are indirectly connected, coupled, supported, or in contact with each other through a third component.

If a component is referred to as being disposed “on” another component, it includes not only a case where the component is in contact with another component, but also a case where yet another component exists between the two components.

A term “and/or” includes any one or a combination of a plurality of related items.

An expression a “device configured to” in any context may indicate that the device may “perform˜” together with another device or component. For example, a “processor configured (or set) to perform A, B, and C” may indicate a dedicated processor (for example, an embedded processor) that may perform the corresponding operations or a generic-purpose processor (for example, a central processing unit (CPU) or an application processor) that may perform the corresponding operations by executing one or more software programs stored in a memory device.

In an embodiment, a “module” or a “part” may perform at least one function or operation, and be implemented by hardware or software or be implemented by a combination of hardware and software. In addition, a plurality of “modules” or a plurality of “parts” may be integrated in at least one module and be implemented by at least one processor except for a “module” or a “part” that needs to be implemented by specific hardware.

The various elements and areas in the drawings are schematically shown. Therefore, the spirit of the present disclosure is not limited by relative sizes or intervals shown in the accompanying drawings.

Hereinafter, an embodiment of the present disclosure is described in detail with

reference to the accompanying drawings.

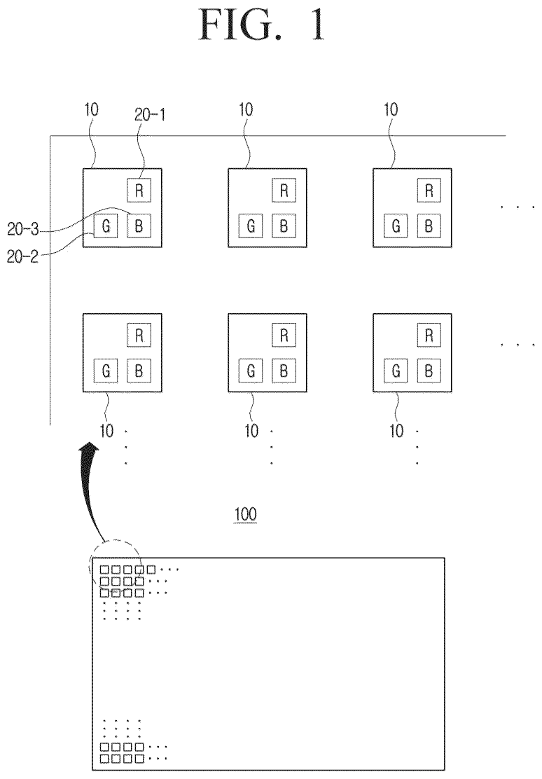

FIG. 1 is a diagram for describing a pixel structure of a display panel according to an embodiment of the present disclosure.

Referring to FIG. 1, a display panel 100 may include a plurality of pixels 10 disposed (or arranged) in a matrix form, that is, a pixel array.

The pixel array may include a plurality of row lines or a plurality of column lines. In some cases, the row line may be referred to as a horizontal line, a scan line, or a gate line, and the column line may be referred to as a vertical line or a data line.

Alternatively, in some cases, the terms indicating the row line, the column line, the horizontal line, and the vertical line may be used to refer to lines formed by pixels on the pixel array, and the terms indicating the scan line, the gate line, and the data line may be used to refer to actual wiring on the display panel 100 through which data or signals are transmitted.

Each pixel 10 in the pixel array may include three types of sub-pixels, such as a red (R) sub-pixel 20-1, a green (G) sub-pixel 20-2, and a blue (B) sub-pixel 20-3.

Each pixel 10 may include a plurality of light-emitting elements constituting the plurality of sub-pixels 20-1, 20-2, and 20-3.

For example, each pixel 10 may include three types of light-emitting elements, such as an R light-emitting element included in the R sub-pixel 20-1, a G light-emitting element included in the G sub-pixel 20-2, and a B light-emitting element included in the B sub-pixel 20-3.

Alternatively, each pixel 10 may include three blue light-emitting elements. In this case, a color filter for implementing an R, G, or B color may be disposed on each light-emitting element. Here, the color filter may be a quantum dot (QD) color filter, and is not limited to this example.

In this way, the display panel 100 may have the plurality of pixels 10 including the plurality of sub-pixels 20-1, 20-2, and 20-3, respectively, disposed in the matrix form.

Each of the sub-pixels 20-1, 20-2, and 20-3 may include the light-emitting element and a pixel circuit that drives the light-emitting element. The pixel circuit may be disposed for each light-emitting element.

FIG. 1 shows an example in which the sub-pixels 20-1 to 20-3 are arranged in an L-shape with the left and right reversed within one pixel region. However, the arrangement is not limited to this example, and the R, G, B sub-pixels 20-1 to 20-3 may be disposed in a row in a pixel region, or may be disposed in various forms in some embodiments.

In addition, with reference to FIG. 1, the description describes an example in which three types of sub-pixels are included in one pixel. However, in some embodiments, four types of sub-pixels, such as R, G, B, and white (W), may be included in one pixel, or any other number of sub-pixels may be included in one pixel.

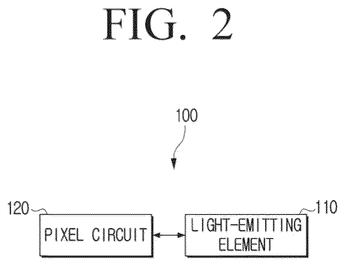

FIG. 2 is a block diagram for describing a configuration of the display panel according to an embodiment of the present disclosure.

Referring to FIG. 2, the display panel 100 may include a light-emitting element 110 and a pixel circuit 120. In providing the description with reference to FIG. 2, the description omits or abbreviates parts that overlap with parts already described.

For convenience of description, FIG. 2 shows only one sub-pixel related configuration included in the display panel 100. However, as described above, the display panel 100 may include the plurality of pixels 10, and each pixel 10 may include the plurality of sub-pixels 20-1, 20-2, and 20-3. In this case, the light-emitting element 110 and the pixel circuit 120 may be disposed in each sub-pixel.

The light-emitting element 110 may be electrically connected to the pixel circuit 120. In addition, the light-emitting element 110 may emit light based on a driving current provided by the pixel circuit 120.

The display panel 100 may include a plurality of types of light-emitting elements 110. In detail, the display panel 100 may include the plurality of pixels 10, and each pixel 10 may include the plurality of sub-pixels 20-1, 20-2, and 20-3. The plurality of sub-pixels 20-1, 20-2, and 20-3 may include the R sub-pixel 20-1, the G sub-pixel 20-2, and the B sub-pixel 20-3. The R sub-pixel 20-1 may include a red light-emitting element that emits red color light, the G sub-pixel 20-2 may include a green light-emitting element that emits green color light, and the B sub-pixel 20-3 may include the blue light-emitting element that emits blue color light.

The light-emitting element 110 may include the light-emitting element manufactured using an inorganic material, unlike an organic light-emitting diode (OLED) manufactured using an organic material. Therefore, the light-emitting element 110 may also be referred to as an inorganic light-emitting element.

In particular, according to an embodiment of the present disclosure, the light-emitting element 110 may be a micro light-emitting diode (micro LED or uLED). The micro light-emitting diode may be a light-emitting diode having a size of 100 micrometers (μm) or less.

The display panel in which each sub-pixel is implemented as the micro LED may be referred to as a micro LED display panel. The micro LED display panel may be one of flat display panels, and may include a plurality of light-emitting diodes (inorganic LEDs), each of which is 100 micrometers or less. The micro LED display panel may provide better contrast, response time, and energy efficiency than a liquid crystal display (LCD) panel that requires a backlight.

The light-emitting element 110 may express gradation values of different brightness based on a magnitude of the driving current provided by the pixel circuit 120 and/or a pulse width of the driving current. Here, the pulse width of the driving current may be referred to as a duty ratio of the driving current or duration of the driving current.

For example, the light-emitting element 110 may express a brighter gradation value as the magnitude of the driving current increases. In addition, the light-emitting element 110 may express the brighter gradation value as the pulse width of the driving current increases (that is, the duty ratio increases or the duration increases).

The pixel circuit 120 may provide the driving current to the light-emitting element 110 in case of driving the display panel 100. The pixel circuit 120 may include a transistor or the like, and may be disposed on a thin film transistor (TFT) layer of the display panel 100.

The pixel circuit 120 may control luminance of light emitted by the light-emitting element 110 by driving the light-emitting element 110 by using pulse amplified modulation (PAM) and/or pulse width modulation (PWM). That is, the pixel circuit 120 may provide the driving current whose magnitude and/or the duration is controlled to the corresponding light-emitting element 110.

The light-emitting elements 110 included in the pixel array may emit light based on the driving current provided by the corresponding pixel circuits 120, and accordingly, an image may be displayed on the display panel 100.

According to an embodiment of the present disclosure, the pixel circuit 120 may include a reset circuit that removes charges remaining in the light-emitting element 110. Details thereof are described below.

A time period during which the driving current is provided to the light-emitting element 110 may be referred to as a light emitting period. According to an embodiment of the present disclosure, a plurality of light emitting periods may proceed during one frame.

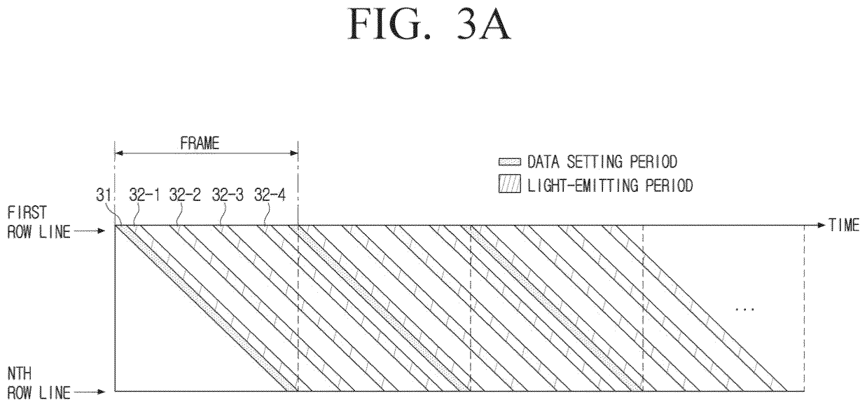

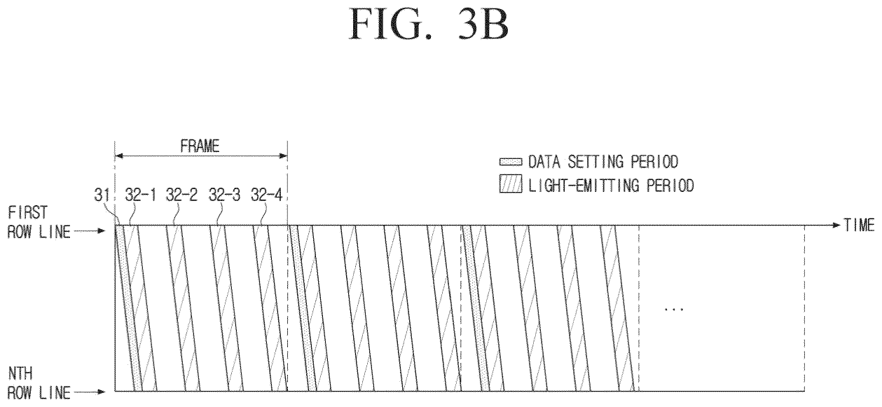

FIGS. 3A and 3B are conceptual diagrams showing a method for driving the display panel according to an embodiment of the present disclosure.

FIGS. 3A and 3B show an example of a method for driving the display panel 100 for three consecutive frames (i.e., image frames). In FIGS. 3A and 3B, a horizontal axis represents time, and a vertical axis represents the row lines (i.e., n row lines) of the display panel 100.

A data setting period 31 represents a period in which an image data voltage is set to the pixel circuits 120 included in each row line. Light-emitting periods 32-1, 32-2, 32-3, and 32-4 represent periods in which the driving current is provided to the light-emitting element 110 based on the image data voltage set during the data setting period 31.

Referring to FIG. 3A, the display panel 100 may be driven by being classified into a plurality of sub-frames for each frame.

Here, a sub-frame period may indicate the light-emitting period. That is, during one frame period, the plurality of the light-emitting periods may be performed for each row line, and the driving current may be provided to the light-emitting element 110 in each light-emitting period. Time intervals between the plurality of the light-emitting periods 32-1, 32-2, 32-3, and 32-4 may be the same as one another.

In this way, the method for driving a display panel 100 by the light-emitting elements 110 included in the row line and emitting light multiple times for each row line for each frame may be referred to as a multi-emission method. However, such a name is not limited to this example. If the light-emitting element 110 is the micro LED, a color shift problem may occur due to device characteristics of the micro LED, and this problem may be solved through multi-emission driving.

FIG. 3A shows an example in which the light-emitting periods 32-1, 32-2, 32-3, and 32-4 are performed four times based on the image data voltage set in the data setting period 31. This configuration is shown for the convenience of description, and the display panel 100 may be driven 10 to 20 times per frame. However, the number of times the light-emitting periods are performed is not limited to this example.

In addition, referring to FIG. 3A, the pixel circuits 120 included in each row line of the display panel 100 may be driven sequentially in a row line order. That is, the data setting period and light-emitting period of the row line may be performed sequentially in the row line order.

For one frame, one data setting period 31 and the plurality of the light-emitting periods 32-1, 32-2, 32-3, and 32-4 may be performed for each row line.

During the data setting period 31, the image data voltage for the frame may be set (or applied) to the pixel circuits 120 included in the row line. In addition, in each of the light-emitting periods 32-1, 32-2, 32-3, and 32-4, the driving current may be provided to the corresponding light-emitting element 110 based on the image data voltage set during the data setting period 31. Accordingly, the light-emitting element 110 may emit light based on the driving current, and the display panel 100 may display the image.

In an embodiment shown in FIG. 3A, the data setting period may be performed during one frame period. On the other hand, in an embodiment shown in FIG. 3B, the data setting period may be performed during a shorter time than one frame period, which is different from that in FIG. 3A. However, except for this point, the description provided above with reference to FIG. 3A may be applied as it is, and a redundant description thereof is thus omitted.

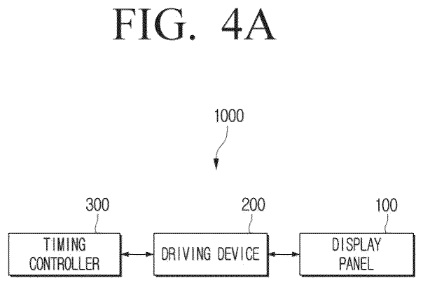

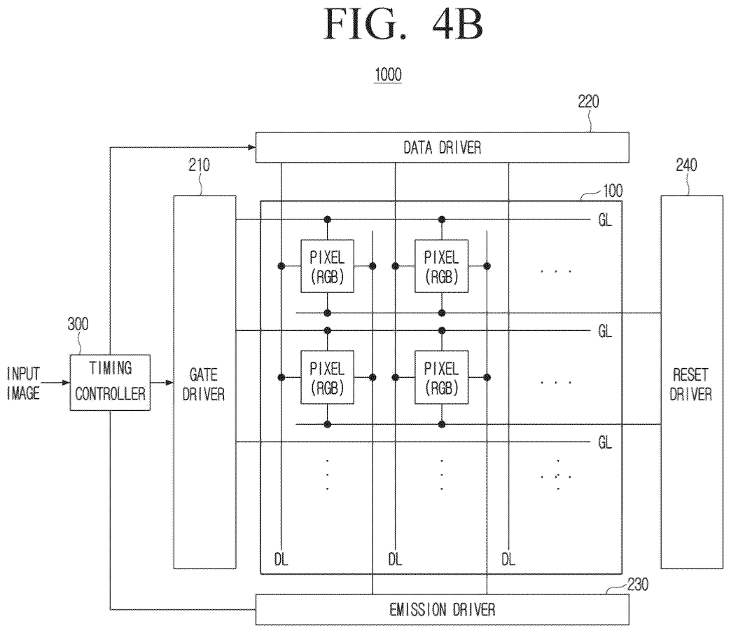

FIGS. 4A and 4B are block diagrams for describing a configuration of a display device according to an embodiment of the present disclosure.

Referring to FIGS. 4A and 4B, a display device 1000 may include the display panel 100, a driving device 200, and a timing controller (TCON) 300. In providing the description with reference to FIGS. 4A and 4B, the description omits or abbreviates parts that overlap with parts already described.

The driving device 200 may set the image data voltage to the pixel circuits 120 in the display panel 100 in the row line order during the data setting period, and drive the pixel circuits 120 to enable the light-emitting elements 110 in the pixel array to emit light in the row line order based on set image data.

For example, the driving device 200 may include a gate driver 210, a data driver 220, and an emission driver 230.

The gate driver 210 may apply a scan signal to the pixel circuits 120 in the row line order. The gate driver 210 may apply the scan signal to the pixel circuits 120 in the row line order from the first to last row lines of the display panel 100. The scan signal may be applied to the pixel circuit 120 through a gate line GL.

The data driver 220 may convert the image data into the image data voltage in an analog form, and set the image data voltage to the pixel circuit 120 selected through the scan signal. The image data voltage may be applied to the pixel circuit 120 through a data line DL. In this case, the image data voltage corresponding to each of the R, G, and B sub-pixels included in one pixel may be time-division multiplexed through a demultiplexer (DeMUX) circuit and applied to the pixel circuit 120 of each of the R, G, and B sub-pixels. According to an embodiment, a separate data line may be disposed for each of the R, G, and B sub-pixels. The image data voltage applied to each of the R, G, and B sub-pixels may be simultaneously applied to the corresponding sub-pixel through the corresponding data line. In this case, the DeMUX circuit may be omitted.

The emission driver 230 may apply an emission signal EM to the pixel circuit 120. The emission signal EM refers to a signal for controlling the driving current provided to the light-emitting element 110. That is, based on the emission signal EM, the driving current having a magnitude corresponding to that of the image data voltage may be provided to the light-emitting element 110, and the duration of the light-emitting element 110 may be determined.

The emission driver 230 may apply the scan signal to the pixel circuits 120 in the row line order from the first row line to the last row line. In addition, the emission driver 230 may apply the emission signal EM to the pixel circuits 120 in each row line multiple times.

Accordingly, as described above with reference to FIGS. 3A and 3B, the image data voltage may be set to the pixel circuits 120 in the row line order in the data setting period, and the light-emitting elements 110 in the pixel array may emit light in the row line order in the light-emitting period based on the image data voltage. In this case, the plurality of light-emitting periods may be performed for each row line.

In addition, the driving device 200 may include a reset driver 240. The reset driver 240 may apply a reset signal RST to the pixel circuit 120. A period during which the reset signal is provided to the pixel circuit 120 may be referred to as a reset period.

For example, the reset driver 240 may apply the reset signal RST to the pixel circuits 120 in the row line order from the first row line to the last row line. Alternatively, the reset driver 240 may apply the reset signal RST equally to all the pixel circuits 120 in the display panel 100.

The reset signal RST may be a signal for removing the charges remaining in the light-emitting element 110. Here, removing the charges remaining in the light-emitting element 110 may include removing the charges remaining in a junction capacitance of the light-emitting element 110.

Referring to FIGS. 3A and 3B, according to an embodiment of the present disclosure, no blanking time may occur between the frame period and a frame period consecutive to the frame period. That is, no blanking time may occur between two consecutive frames.

The blanking time may indicate a period (e.g., a non-driving period) during which the display panel 100 is not driven between an end of the data setting period and the light-emitting period in one frame and a start of the data setting period in a next frame.

Even after the light-emitting element 110 ends emitting light, the charges may remain in the light-emitting element 110. This configuration may cause the light-emitting element 110 to slightly emit light even after the light-emitting period ends. If the blanking time exists, this emission may cause flicker. Therefore, in an embodiment of the present disclosure, the flicker problem may be improved by removing the blanking period.

The charges remaining in the light-emitting element 110 may cause a problem even within the frame period. In particular, in expressing a black gradation, if the light-emitting element 110 emits light due to the remaining charges, luminance of a black screen may increase, which may interfere with implementation of accurate black gradation. Therefore, according to an embodiment of the present disclosure, the charges remaining in the light-emitting element 110 may be discharged during a specific period within the frame period by using the reset signal RST, thereby implementing a more perfect black gradation.

The driving device 200 may include a power integrated circuit (IC) for providing various direct current (DC) voltages (e.g., driving voltage VDD and ground voltage VSS) to the pixel circuit 120 included in the display panel 100.

In addition, the driving device 200 may include a shift register for shifting levels of various signals provided by the timing controller 300 to levels used by the driver (for example, the gate driver, the data driver, or the emission driver) or the display panel 100.

According to an embodiment of the present disclosure, at least some of the components included in the driving device 200 may be disposed on the TFT layer of the display panel 100 and connected to the pixel circuits disposed on the TFT layer. In this way, a structure in which the driver is disposed on the TFT layer may be referred to as a gate-in-panel (GIP) structure, and the name is not limited to this example.

In addition, at least some of the components included in the driving device 200 may be disposed on the side surface or rear surface (that is, a surface opposite to a surface of the substrate on which the TFT layer is disposed) of a substrate of the display panel 100, and may be connected to the pixel circuits disposed on the TFT layer of the display panel 100 through the wiring.

In addition, at least some of the components included in the driving device 200 may be disposed on a printed circuit board (PCB) separate from the display panel 100 and connected to the pixel circuits disposed on the TFT layer of the display panel 100 through the wiring.

In addition, at least some of the components included in the driving device 200 may be implemented as IC-type driver chips.

The timing controller 300 may drive the driving device 200 to display the image on the display panel 100.

For example, the timing controller 300 may control the gate driver 210 to start scanning based on a timing corresponding to each frame. Accordingly, the scan signal may be applied to the pixel circuits 120 in the row line order.

In addition, the timing controller 300 may provide the image data to the data driver 220, and control the data driver 220 to apply the image data voltage corresponding to the image data to the pixel circuits 120. Accordingly, the image data voltage may be set to the pixel circuits 120 in the row line order.

In addition, the timing controller 300 may control the emission driver 230 to cause the light-emitting elements 110 to emit light based on the image data voltage. Accordingly, the emission signal EM may be applied to the pixel circuits 120 in the row line order.

Accordingly, the pixel circuit 120 may provide the driving current to the light-emitting element 110 based on the image data voltage, and the light-emitting element 110 may emit light based on the driving current. Accordingly, the display panel 100 may display the image.

In addition, the timing controller 300 may control the reset driver 240 to apply the reset signal RST to the pixel circuits 120.

The display device 1000 may include at least one processor (hereinafter, the processor) that controls overall operations of the display device 1000. The processor may be implemented as at least one of a central processing unit (CPU), a micro-controller, an application processor (AP), a communication processor (CP), or an advanced RISC machine (ARM) processor.

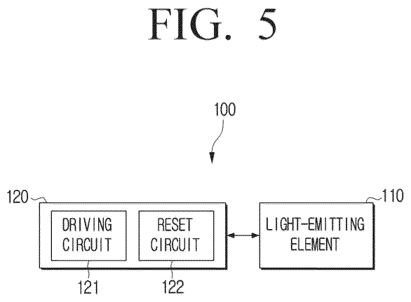

FIG. 5 is a diagram for describing the pixel circuit according to an embodiment of the present disclosure.

The pixel circuit 120 may provide the driving current to the light-emitting element 110 in each of the plurality of sub-frame periods within the frame period. In addition, the pixel circuit 120 may remove the charges remaining in the light-emitting element 110 during the reset period within the frame period other than the plurality of sub-frames.

To this end, the pixel circuit 120 may include a driving circuit 121 and a reset circuit 122.

The driving circuit 121 may include a circuit that provides the driving current to the light-emitting element 110. The driving circuit 121 may drive the light-emitting element 110 by using the PAM and/or the PWM to thus control the luminance of light emitted by the light-emitting element 110.

For example, the driving circuit 121 may provide the driving current having a predetermined magnitude to the light-emitting element 110 by using the image data voltage, and control a time during which the driving current flows through the light-emitting element 110. In this way, the driving circuit 121 may provide the driving current whose magnitude and duration are controlled to the light-emitting element 110 based on the image data voltage.

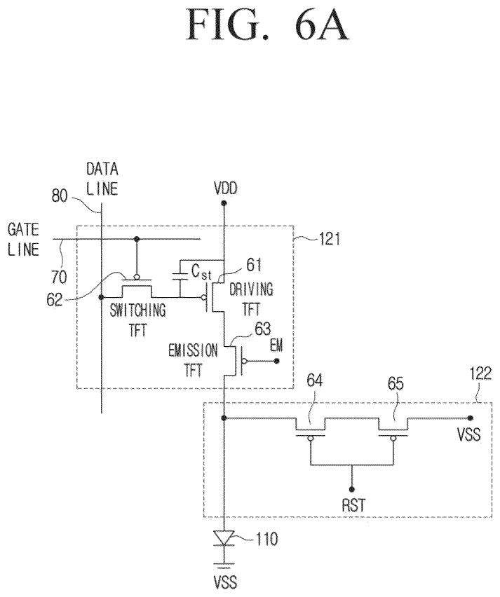

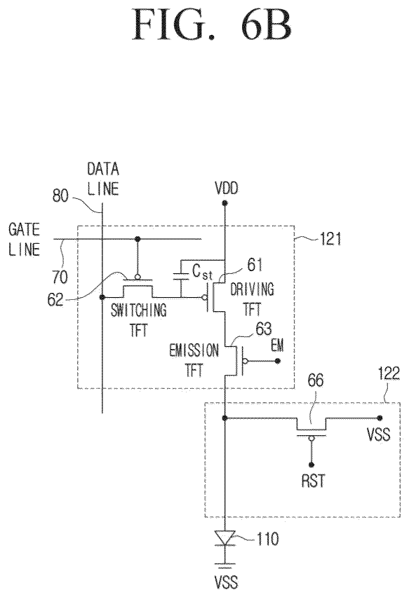

FIGS. 6A and 6B are circuit diagrams of the pixel circuit according to an embodiment of the present disclosure.

For the convenience of description, FIGS. 6A and 6B schematically show a circuit included in the driving circuit 121. However, the driving circuit 121 is not limited to this example, and may include various circuit structures capable of driving the light-emitting element 110 by using the PAM and/or the PWM.

Referring to FIG. 6A, the driving circuit 121 may include a driving transistor 61, a switching transistor 62, and an emission transistor 63.

The light-emitting element 110 may have an anode terminal connected to a drain terminal of the emission transistor 63 and a cathode terminal connected to the ground voltage VSS (e.g., zero [V]).

The driving circuit 121 may provide the driving current having a predetermined magnitude to the light-emitting element 110 based on a voltage applied between the source terminal and gate terminal of the driving transistor 61.

For example, the switching transistor 62 may be turned on if the scan signal is applied to the gate terminal of the switching transistor 62 through a gate line 70. In addition, the image data voltage may be applied to the gate terminal of the driving transistor 61 through the turned-on switching transistor 62 if the image data voltage is applied to the source terminal of the switching transistor 62 through a data line 80 while the switching transistor 62 is turned on. The image data voltage may be charged to a capacitor Cₛₜ.

Next, if the driving voltage VDD is applied to the source terminal of the driving transistor 61, the driving circuit 121 may provide the driving current having a magnitude based on a difference between the source terminal voltage and gate terminal voltage of the driving transistor 61 to the light-emitting element 110 through the turned-on driving transistor 61.

The driving current may be provided to the light-emitting element 110 while the emission transistor 63 is turned on. In detail, the driving circuit 121 may control the time during which the driving current flows to the light-emitting element 110 by controlling a turning-on/off operation of the emission transistor 63 based on the emission signal EM applied to the gate terminal of the emission transistor 63.

The reset circuit 122 may include a circuit that removes the charges remaining in the light-emitting element 110 during the reset period within the frame period other than the plurality of sub-frame periods.

To this end, the reset circuit 122 may include at least one transistor connected between the light-emitting element 110 and the ground voltage VSS. At least one transistor may be turned on during the reset period and discharge the charges remaining in the light-emitting element 110 to the ground voltage VSS while being turned on. At least one transistor may be turned on by the reset signal applied thereto during the reset period.

For example, the reset circuit 122 may include a first transistor 64 and a second transistor 65.

The first transistor 64 may have a source terminal connected to the anode terminal of the light-emitting element 110 and a drain terminal connected to a source terminal of the second transistor 65. A gate terminal of the first transistor 64 may receive the reset signal RST.

The second transistor 65 may have the source terminal connected to the drain terminal of the first transistor 64 and a drain terminal connected to the ground voltage VSS of the second transistor 65. A gate terminal of the second transistor 65 may receive the reset signal RST.

The first transistor 64 and the second transistor 65 may be turned on based on the reset signal RST applied to the gate terminals of the first transistor 64 and the second transistor 65, respectively, during the reset period. The reset signal may be provided by the driving device 200 (specifically, the reset driver 240).

If the first transistor 64 and the second transistor 65 are turned on, the anode terminal of the light-emitting element 110 may be connected to the ground voltage VSS. In this case, the charges remaining on the light-emitting element 110 may be completely discharged to a terminal for the ground voltage VSS through the turned-on first and second transistors 64 and 65. Accordingly, afterglow of the light-emitting element 110 may be removed.

Referring to FIG. 6A, the reset circuit 122 may include the two transistors 64 and 65. This configuration is provided to prevent the luminance of the light-emitting element 110 from being reduced due to a leakage current of the transistor. In detail, the micro LED display panel may require a higher current than the OLED display panel. Therefore, a low-temperature polycrystalline silicon (LTPS) TFT may be used as a TFT included in the TFT layer of the micro LED display panel. However, the leakage current may occur in the LTPS TFT. Luminance of the micro LED display panel may be reduced if the leakage current occurs through the transistor included in the reset circuit 122. Therefore, according to an embodiment of the present disclosure, to reduce the leakage current, the reset circuit 122 may be configured by connecting the two transistors 64 and 65 to each other. However, FIG. 6A shows that the reset circuit 122 includes the two transistors 64 and 65, is not limited to this example, and may be configured by connecting two or more transistors.

In addition, according to an embodiment of the present disclosure, a leakage current amount may be reduced by adjusting a length of the transistor. In detail, the leakage current amount may be reduced if the length of the transistor increases. Considering this point, according to an embodiment of the present disclosure, as shown in FIG. 6B, the reset circuit 122 may include a third transistor 66. Here, a length of the third transistor 66 may be a predetermined value or more. That is, in a stage of manufacturing the display panel 100, the length of the third transistor 66 may be determined to prevent the luminance of the micro LED display panel from being reduced due to the leakage current.

The third transistor 66 may have a source terminal connected to the anode terminal of the light-emitting element 110 and a drain terminal connected to the ground voltage VSS. A gate terminal of the third transistor 66 may receive the reset signal RST.

The third transistor 66 may be turned on based on the reset signal RST applied to the gate terminal of the third transistor 66 during the reset period. The reset signal may be provided by the driving device 200 (specifically, the reset driver 240).

If the third transistor 66 is turned on, the anode terminal of the light-emitting element 110 may be connected to the ground voltage VSS. In this case, charges remaining in the light-emitting element 110 may be completely discharged to the terminal for the ground voltage VSS through the turned-on third transistor 66. Accordingly, the afterglow of the light-emitting element 110 may be removed.

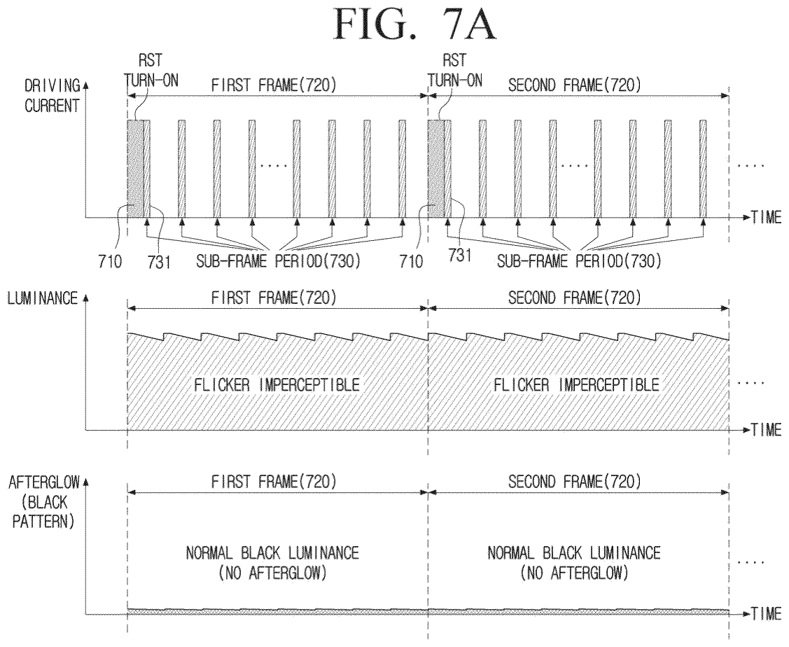

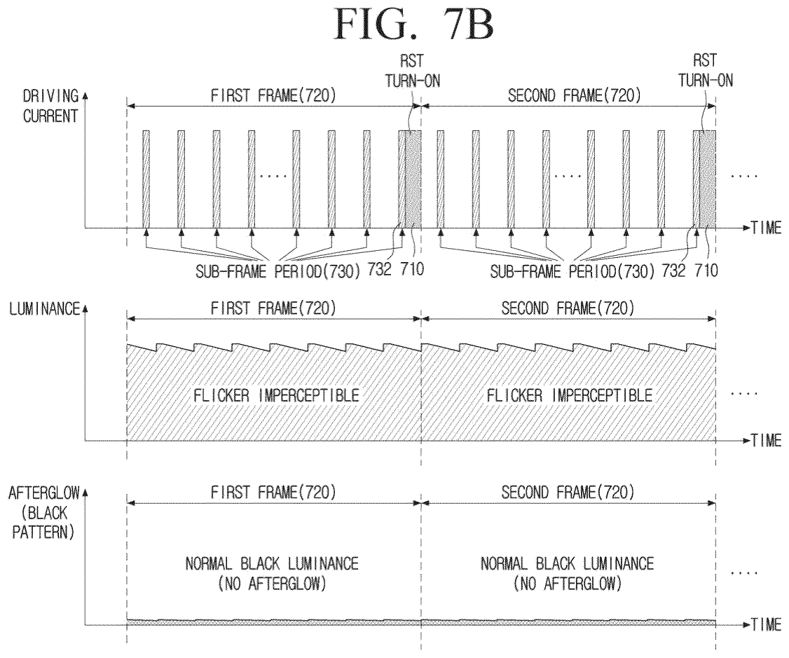

FIGS. 7A and 7B are diagrams for describing the reset period according to an embodiment of the present disclosure.

For each frame, the reset period may be disposed in a time period within the frame period other than the plurality of sub-frame periods.

For example, as shown in FIG. 7A, a reset period 710 may be disposed before a first sub-frame period 731 among a plurality of sub-frame periods 730 within a frame period 720. That is, for each frame, the reset period 710 may be disposed within the frame period, and may be disposed before the first sub-frame period within the frame period. In this case, the reset period 710 may be disposed before the data setting period within the frame period. The reset period 710 may be disposed between the data setting period and the first sub-frame period within the frame period.

Accordingly, if the frame has the black gradation, the black gradation may be perfectly expressed because, for each frame, the charges remaining in the light-emitting element 110 may be removed before the light-emitting period of the frame begins.

For example, as shown in FIG. 7B, the reset period 710 may be disposed after a last sub-frame period 732 among the plurality of sub-frame periods 730 within the frame period 720. That is, the reset period 710 may be disposed within the frame period per frame, and may be disposed after the last sub-frame period within the frame period.

Accordingly, if the next frame has the black gradation, the black gradation may be accurately expressed because, for each frame, the charges remaining in the light-emitting element 110 may be removed before the light-emitting period of the next frame starts.

Referring to FIGS. 7A and 7B, according to an embodiment of the present disclosure, in case of driving the display panel 100, the blacking time may be removed to improve the problem of flicker perceived by a user and to remove the charges remaining in the light-emitting element 110 by using the reset period within the frame period, thereby more accurately implementing the black gradation.

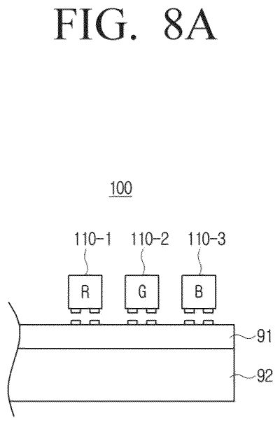

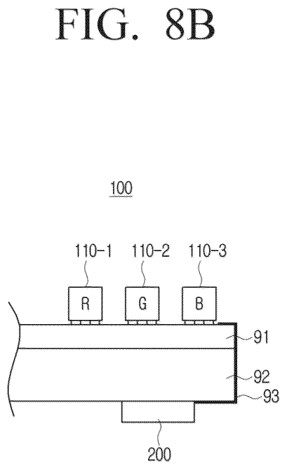

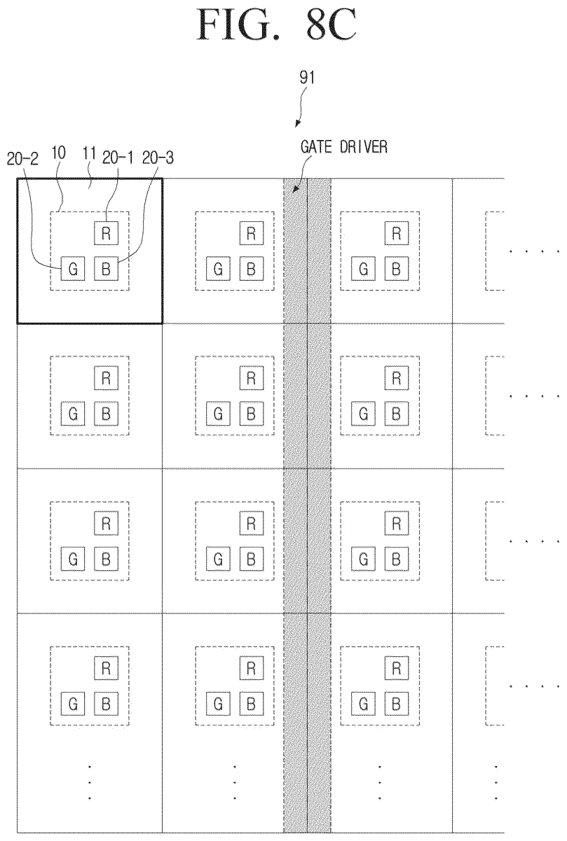

FIGS. 8A and 8B are cross-sectional views of the display panel according to an embodiment of the present disclosure.

FIGS. 8A and 8B show only one pixel included in the display panel 100 for the convenience of description.

Referring to FIG. 8A, the display panel 100 may include a TFT layer 91, a substrate (for example, a glass substrate) 92, and R, G, B light-emitting elements 110-1, 110-2, and 110-3. The pixel circuit 120 may be implemented as a TFT and included in the TFT layer 91 on the substrate 92.

In addition, the TFT layer 91 may have the pixel circuit 120 for providing the driving current to each of the light-emitting elements 110-1, 110-2, and 110-3. Each of the light-emitting elements 110-1, 110-2, and 110-3 may be mounted (or disposed) on the TFT layer 91 to be electrically connected to the corresponding pixel circuit 120.

FIG. 8A shows that the R, G, and B light-emitting elements 110-1, 110-2, and 110-3 are micro LEDs of a flip-chip type. However, the light-emitting element 110-1, 110-2, or 110-3 is not limited to this type, and may be implemented as micro LEDs of a lateral type or a vertical type according to an embodiment.

Referring to FIG. 8B, the TFT layer 91 may be disposed on one surface of the substrate 92. The R, G, and B light-emitting elements 110-1, 110-2, and 110-3 may be mounted on the TFT layer 91. According to an embodiment of the present disclosure, at least some of the aforementioned various components included in the driving device 200 may be disposed on the other surface of the substrate 92.

The pixel circuit 120 disposed on the TFT layer 91 may be electrically connected to the driving device 200 (specifically, at least some of the aforementioned various components included in the driving device 200) through wiring 93 disposed on an edge (or a side surface) of a TFT panel (here, the TFT layer 91 and the substrate 92 are collectively referred to as the TFT panel).

In this way, a reason for connecting the pixel circuit 120 to the driving device 200 through the wiring 93 disposed in an edge region of the display panel 100 is that connecting the pixel circuit 120 to the driving device 200 by forming a hole passing through the substrate 92 may cause a problem such as a crack occurring in the substrate 92 due to a temperature difference between a process for manufacturing the TFT panel and a process for filling the hole with a conductive material.

According to an embodiment of the present disclosure, at least some of the various components included in the driving device 200 may be disposed on the TFT layer 91 together with the pixel circuit 120 and connected to the pixel circuit 120. FIG. 8C shows this embodiment.

FIG. 8C is a plan view of the thin film transistor (TFT) layer according to an embodiment of the present disclosure.

Referring to FIG. 8C, the TFT layer 91 may include a remaining region 11 in addition to a region occupied by one pixel 10 (in this region, the corresponding pixel circuit 120 may exist for each of the R, G, and B sub-pixels 20-1, 20-2, and 20-3 included in the pixel 10). At least some of the various components included in the driving device 200 may be disposed in the remaining region 11.

FIG. 8C shows an example in which the gate driver is disposed in the remaining region 11 of the TFT layer 91. In this way, a structure in which the gate driver is disposed within the TFT layer 91 may be referred to as the GIP structure, and the name is not limited thereto. In addition, a position of the gate driver disposed within the TFT layer 91 is also not limited to the example shown in FIG. 8C.

FIG. 8C shows only an example, and the component disposed in the remaining region 11 of the TFT layer 91 is not limited to the gate driver 210. For example, at least one of the gate driver 210, the data driver 220, the emission driver 230, and the reset driver 240 may be disposed in the remaining region 11 of the TFT layer 91. In addition, according to an embodiment, the TFT layer 91 may further include the DeMUX circuit that selects the R, G, and B sub-pixels 20-1, 20-2, and 20-3, respectively, an electro static discharge (ESD) protection circuit that protects the pixel circuit 120 from static electricity, and the like.

The aforementioned example describes the substrate 92 as the glass substrate, and is not limited to this example. For example, the substrate 92 may be implemented as a synthetic resin substrate, and the TFT layer 91 may be disposed on the synthetic resin substrate. The pixel circuit 120 and the driving device 200 may be connected to each other through a hole passing through the synthetic resin substrate.

The aforementioned example describes that the pixel circuit 120 is disposed in the TFT layer 91, and is not limited to this example. For example, the pixel circuit 120 may be implemented as a pixel-circuit chip in the form of an ultra-small micro IC, and the pixel-circuit chip may be mounted on the substrate. The pixel circuit 120 may be implemented in a sub-pixel unit or a pixel unit. A position where the pixel circuit chip is mounted may be, for example, around the corresponding light-emitting element 110, and is not limited thereto.

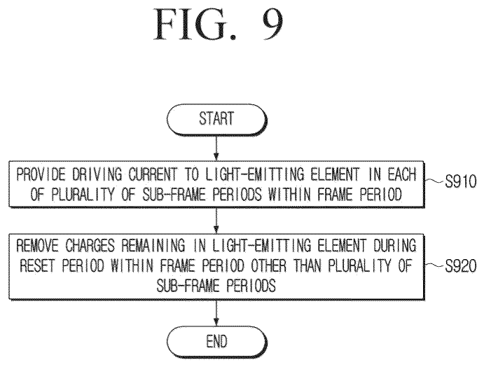

FIG. 9 is a flowchart for describing an afterglow removal method for a display panel according to an embodiment of the present disclosure.

The display panel may include the plurality of pixels disposed in the matrix form, each of which includes the plurality of sub-pixels. In addition, each of the plurality of sub-pixels may include the light-emitting element.

First, the method may include providing the driving current to the light-emitting element in each of the plurality of sub-frame periods within the frame period (S910).

In addition, the method may include removing the charges remaining in the light-emitting element during the reset period within the frame period other than the plurality of sub-frame periods (S920).

In addition, the reset period may be disposed before the first sub-frame period among the plurality of sub-frame periods within the frame period.

In addition, the reset period may be disposed after the last sub-frame period among the plurality of sub-frame periods within the frame period.

In addition, the reset circuit may include at least one transistor connected between the light-emitting element and the ground voltage, and at least one transistor may be turned on during the reset period and may discharge the charges remaining in the light-emitting element to the ground voltage while being turned on.

In addition, at least one transistor may include the first transistor having the source terminal connected to the anode terminal of the light-emitting element and the second transistor having the source terminal connected to the drain terminal of the first transistor and the drain terminal connected to the ground voltage. In this case, in step S920, the reset signal may be applied to the gate terminal of each of the first transistor and the second transistor during the reset period to turn on the first transistor and the second transistor.

In addition, at least one transistor may include the third transistor having the source terminal connected to the anode terminal of the light-emitting element and the drain terminal connected to the ground voltage. The length of the third transistor may be greater than or equal to a predetermined value. In this case, in step S920, the third transistor may be turned on by applying the reset signal to the gate terminal of the third transistor during the reset period.

In addition, the light-emitting element may be the micro LED.

In addition, no blanking time may occur between the frame periods and the frame period consecutive to the frame period.

According to an embodiment of the present disclosure, the various embodiments described above may be implemented in software including an instruction stored on a machine-readable storage medium (for example, a computer-readable storage medium). A machine may be a device that invokes the stored instruction from a storage medium, may be operated based on the invoked instruction, and may include an electronic apparatus (e.g., electronic apparatus A) according to the disclosed embodiments. If the instruction is executed by the processor, the processor may directly perform a function corresponding to the instruction or other components may perform the function corresponding to the instruction under control of the processor. The instruction may include codes generated or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

In addition, according to an embodiment, the methods according to the various embodiments described above may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store (for example, PlayStore™). In case of the online distribution, at least a part of the computer program product may be at least temporarily stored or temporarily generated on a storage medium such as the memory of a manufacturer server, an application store server, or a relay server.

In addition, according to an embodiment of the present disclosure, the various embodiments described above may be implemented in a computer or a computer-readable recording medium using software, hardware, or a combination of software and hardware. In some cases, the embodiments described in the specification may be implemented by a processor itself. According to software implementation, the embodiments such as the procedures and functions described in the specification may be implemented by separate software modules. Each of the software modules may perform one or more functions and operations described in the specification.

Computer instructions for performing processing operations of the machines according to the various embodiment of the present disclosure described above may be stored in a non-transitory computer-readable medium. The computer instructions stored in the non-transitory computer-readable medium may allow a specific device to perform the processing operations of the device according to the various embodiments described above in case that the computer instructions are executed by a processor of the specific device. The non-transitory computer-readable medium is not a medium that stores data therein for a while, such as a register, a cache, or a memory, and indicates a medium that semi-permanently stores data therein and is readable by the machine. A specific example of the non-transitory computer-readable medium may include a compact disk (CD), a digital versatile disk (DVD), a hard disk, a Blu-ray disk, a universal serial bus (USB), a memory card, a read-only memory (ROM), or the like.

In addition, each of the components (for example, modules or programs) according to the various embodiments described above may include a single entity or a plurality of entities, and some of the corresponding sub-components described above may be omitted or other sub-components may be further included in the various embodiments. Alternatively or additionally, some of the components (e.g., modules or programs) may be integrated into one entity, and may perform functions performed by the respective corresponding components before being integrated in the same or similar manner. Operations performed by the modules, the programs or other components according to the various embodiments may be executed in a sequential manner, a parallel manner, an iterative manner or a heuristic manner, and at least some of the operations may be performed in a different order, omitted, or supplemented with other operations.

Although embodiments of the present disclosure have been shown and described hereinabove, the present disclosure is not limited to the above-mentioned specific embodiments, and may be variously modified by those skilled in the art to which the present disclosure pertains without departing from the scope and spirit of the present disclosure as disclosed in the accompanying claims. These modifications should also be understood to fall within the scope and spirit of the present disclosure.

What is claimed is:

1. A display panel comprising:
a plurality of pixels provided in a matrix, each pixel comprising a plurality of sub-pixels,
wherein each pixel of the plurality of sub-pixels comprises:
a light-emitting element, and
a pixel circuit configured to provide a driving current to the light-emitting element in each sub-frame period of a plurality of sub-frame periods within a frame period, and
wherein the pixel circuit comprises a reset circuit configured to remove charges remaining in the light-emitting element during a reset period within the frame period other than the plurality of sub-frame periods.

2. The display panel as claimed in claim 1, wherein the reset period is before a first sub-frame period among the plurality of sub-frame periods within the frame period.

3. The display panel as claimed in claim 1, wherein the reset period is after a last sub-frame period among the plurality of sub-frame periods within the frame period.

4. The display panel as claimed in claim 1, wherein the reset circuit comprises at least one transistor connected between the light-emitting element and a ground voltage, and
wherein the at least one transistor is configured to be turned on during the reset period and discharge the charges remaining in the light-emitting element to the ground voltage while being turned on.

5. The display panel as claimed in claim 4, wherein the at least one transistor comprises:
a first transistor having a source terminal connected to an anode terminal of the light-emitting element, and
a second transistor having a source terminal connected to a drain terminal of the first transistor and a drain terminal connected to the ground voltage,
wherein the first transistor and the second transistor are configured to be turned on based on a reset signal applied to a gate terminal of each of the first transistor and the second transistor during the reset period.

6. The display panel as claimed in claim 4, wherein the at least one transistor comprises a third transistor having a source terminal connected to an anode terminal of the light-emitting element and a drain terminal connected to the ground voltage,
wherein a length of the third transistor is greater than or equal to a predetermined value, and
wherein the third transistor is configured to be turned on based on a reset signal applied to a gate terminal of the third transistor during the reset period.

7. The display panel as claimed in claim 1, wherein the light-emitting element is a micro light-emitting diode (LED).

8. The display panel as claimed in claim 1, wherein no blanking time occurs between the frame period and a frame period consecutive to the frame period.

9. A method for removing afterglow in a display panel, in which a plurality of pixels, each pixel including a plurality of sub-pixels, are provided in a matrix form, each sub-pixel of the plurality of sub-pixels including a light-emitting element, the method comprising:
providing a driving current to the light-emitting element in each sub-frame period of a plurality of sub-frame periods within a frame period; and
removing charges remaining in the light-emitting element during a reset period within the frame period other than the plurality of sub-frame periods.

10. The method as claimed in claim 9, wherein the reset period is before a first sub-frame period among the plurality of sub-frame periods within the frame period.

11. The method as claimed in claim 9, wherein the reset period is after a last sub-frame period among the plurality of sub-frame periods within the frame period.

12. The method as claimed in claim 9, wherein a reset circuit comprises at least one transistor connected between the light-emitting element and a ground voltage, and
wherein the at least one transistor is turned on during the reset period and discharges the charges remaining in the light-emitting element to the ground voltage while being turned on.

13. The method as claimed in claim 12, wherein the at least one transistor comprises:
a first transistor having a source terminal connected to an anode terminal of the light-emitting element, and
a second transistor having a source terminal connected to a drain terminal of the first transistor and a drain terminal connected to the ground voltage, and
wherein in the removing, the first transistor and the second transistor are turned on by applying a reset signal to a gate terminal of each of the first transistor and the second transistor during the reset period.

14. The method as claimed in claim 12, wherein the at least one transistor comprises a third transistor having a source terminal connected to the anode terminal of the light-emitting element and a drain terminal connected to the ground voltage,
wherein a length of the third transistor is greater than or equal to a predetermined value, and
wherein in the removing, the third transistor is turned on by applying a reset signal to a gate terminal of the third transistor during the reset period.

15. The method as claimed in claim 9, wherein the light-emitting element is a micro light-emitting diode (LED).

16. The method as claimed in claim 9, wherein no blanking time occurs between the frame period and a frame period consecutive to the frame period.
